(19) United States
(12) Patent Application Publication
(10) Pub. No.: US 2026/0110396 A1
(43) Pub. Date: Apr. 23, 2026

(54) EMERGENCY RELEASE FOR TELEVISION WALL MOUNT

(71) Applicant: Legrand AV Inc., Minnetonka, MN (US)

(72) Inventors: Mathew Schuh, Minnetonka, MN (US); Dorian Farid Haro Gonzalez, Minnetonka, MN (US); Adam Maves, Minnetonka, MN (US)

(21) Appl. No.: 19/329,462

(22) Filed: Sep. 15, 2025

Related U.S. Application Data
(63) Continuation of application No. PCT/US2024/045921, filed on Mar. 14, 2024.
(60) Provisional application No. 63/452,256, filed on Mar. 15, 2023.

(51) Int. Cl. F16M 13/02; F16M 11/10; F16M 11/20

(52) U.S. Cl. CPC F16M 13/02; F16M 11/10; F16M 11/2092; F16M 2200/061

(57) ABSTRACT

Systems and methods are provided enabling installation of an in-wall enclosure and television mount that alleviates the drawbacks of the prior art mounts. The inventions encompass a flexible and modular approach to mounting larger televisions on a stud wall. The television mount includes a display mount with an extension mechanism that can be shifted between a retracted position in which an outer assembly is positioned adjacent an opening in the enclosure and an extended position in which the outer assembly is spaced apart from the enclosure. A latch mechanism latches the display mount in the retracted position. A first release mechanism and an emergency release are provided to enable release of the latch mechanism from outside the enclosure.

### RELATED APPLICATIONS

The present application is a continuation of PCT Application PCT/US2024/045921, entitled EMERGENCY RELEASE FOR TELEVISION WALL MOUNT, filed Sep. 10, 2024, which is a continuation-in-part of PCT Application PCT/US2024/019975, entitled IN-WALL MOUNTING SYSTEM FOR FLAT PANEL TELEVISIONS, filed Mar. 14, 2024, and claims the benefit of U.S. Provisional Application No. 63/452,256, entitled IN-WALL MOUNTING SYSTEM FOR FLAT PANEL TELEVISIONS, filed Mar. 15, 2023, all said priority applications being hereby fully incorporated herein in their entirety by reference.

### TECHNICAL FIELD

The invention is related to television mounts, and more specifically television mounting systems defining in-wall enclosures.

### BACKGROUND

Flat screen televisions and monitors, such as those using LCD, LED, or OLED technology, have become very common. Such devices can provide a large, lightweight, high performance display screen that is also very thin. As technology has improved and prices have decreased, devices with very large display screens, for example 55 diagonal inches and up, have become popular. Also, it can be desirable in larger spaces to mount multiple screens adjacently in an array.

It is often desirable for televisions to be mounted to be freely maneuverable to adjust the orientation of the screen to fit user preferences. For this reason, mounts often have extendable arms and tilt and swivel capability—referred to in the industry as “full-motion” mounts. Especially with larger screens, it is important that the screen be securely mounted and stably supported to prevent wobbling and sagging, and for safety reasons. This means that it is desirable to connect the screen to the mount at two spaced-apart locations.

Moreover, it can be desirable for a television mount to have an enclosure recessed into the wall to contain peripheral devices and wiring that interfere with the ability to position the television close to the wall, and that are also unsightly. A drawback of prior art in-wall mounts is that if an enclosure that spans multiple stud spacings is desired, it is necessary to cut the wall along the entire width of the enclosure to install headers to frame the top and bottom of the enclosure. This leads to increased expense and effort for installation.

Prior art in-wall mount systems often have display mounts retractable into the enclosure and a latch for retaining the display mount in the retracted position. A release cord is typically provided to enable the latch to be released from the front of the display and the display mount extended. A drawback of such systems, however, is that the release cord can become detached, tangled, or inaccessible from the front of the display, leaving no way to release and extend the display mount due to the close proximity of the display to the wall when the display mount is retracted.

What is needed are systems and methods that enable installation of an in-wall enclosure and television mount that alleviates the drawbacks of the prior art mounts.

### SUMMARY

According to embodiments of the inventions disclosed herein, systems and methods are provided that enable installation of an in-wall enclosure and television mount to alleviate the drawbacks of the prior art mounts. These embodiments encompass a flexible and modular approach to mounting larger televisions on a stud wall with an in-wall enclosure without the necessity to cut studs to install headers. Peripherals such as controllers, receivers, routers, and associated wiring can be installed inside the in-wall enclosure for purposes of concealment and enabling the television to be positioned closer to the wall without interference. The enclosures can be installed on both sides of a stud wall, and can be used with surface mounts to enable a wide range of mounting solutions for large televisions and arrays of television displays.

In an embodiment, a mount for attaching an electronic display device to a wall of a structure includes a housing having a pair of opposing side walls, a top wall, a bottom wall, and a rear wall defining an enclosure with a front opening; a pair of side flanges, each side flange presenting a front face and operably coupled to a separate one of the opposing side walls such that the side flange is selectively shiftable to alter a first distance between the front face and the rear wall of the housing. The mount further includes a pair of spaced-apart interface rails extending between the opposing side walls of the housing, each interface rail having a projecting lip, each the interface rail being selectively shiftable to alter a second distance between the projecting lip of the interface rail and the rear wall of the housing, and a pair of display mounts, each display mount removably coupled to each of the interface rails and adapted to attach to the electronic display device to couple the electronic display device to the housing.

In embodiments, the mount further includes an attachment plate disposed inside the enclosure of the housing, the attachment plate adapted to receive a plurality of peripheral electronic devices selected from the group consisting of controllers, receivers, routers, and power supplies. The housing can include a plurality of brackets adapted to attach the housing to a pair of spaced-apart studs of the wall, or each of the side flanges can have a plurality of hardware attachment assemblies for attaching the housing to the wall, each hardware attachment assembly comprising a threaded fastener, a nut, and a clamp.

In embodiments, each of the pair of display mounts includes an inner assembly and an outer assembly coupled by a pair of scissor arms, the inner assembly coupled to the interface rails and the outer assembly adapted to attach to the electronic display device, the scissor arms enabling the electronic display device to be selectively shifted between a first position proximate the housing and a second position spaced-apart from the housing. The outer assembly can include a channel operably coupled to the scissor arms and a display interface adapted to attach to the electronic display device, the display interface operably coupled with the channel so as to enable the display interface to be selectively shifted relative to the channel to vertically tilt the electronic display device. The display interface may be operably coupled with the channel with a tilt adjustment bracket, the tilt adjustment bracket providing a plurality of detent stops such that the electronic display device can be disposed at a plurality of pre-defined tilt positions. The outer assembly may further include a vertical adjustment assembly enabling selective vertical shifting of the outer assembly relative to the scissor arms.

In further embodiments, a system for mounting an electronic display device to a wall of a structure, the system includes a plurality of mounts. Each mount includes a housing having a pair of opposing side walls, a top wall, a bottom wall, and a rear wall defining an enclosure with a front opening; a pair of side flanges, each side flange presenting a front face and operably coupled to a separate one of the opposing side walls such that the side flange is selectively shiftable to alter a first distance between the front face and the rear wall of the housing; a pair of spaced-apart interface rails extending between the opposing side walls of the housing, each interface rail having a projecting lip, each the interface rail being selectively shiftable to alter a second distance between the projecting lip of the interface rail and the rear wall of the housing; and a display mount, the display mount removably coupled to each of the interface rails. The display mount of a first one of the plurality of mounts and the display mount of a second one of the plurality of mounts are attached to the electronic display device to attach the electronic display device to the wall.

According to the system, at least one of the plurality of mounts further includes an attachment plate disposed inside the enclosure of the housing, the attachment plate adapted to receive a plurality of peripheral electronic devices selected from the group consisting of controllers, receivers, routers, and power supplies.

In embodiments, the housing of each mount further includes a plurality of brackets adapted to attach the housing to a pair of spaced-apart studs of the wall, or each of the side flanges of each mount includes a plurality of hardware attachment assemblies for attaching the housing to a wall of a structure, each hardware attachment assembly comprising a threaded fastener, a nut, and a clamp.

In embodiments, each of the display mounts includes an inner assembly and an outer assembly coupled by a pair of scissor arms, the inner assembly coupled to the interface rails and the outer assembly adapted to attach to the electronic display device, the scissor arms enabling the electronic display device to be selectively shifted between a first position proximate the housing and a second position spaced-apart from the housing. The outer assembly can include a channel operably coupled to the scissor arms and a display interface adapted to attach to the electronic display device, the display interface operably coupled with the channel so as to enable the display interface to be selectively shifted relative to the channel to vertically tilt the electronic display device. The display interface may be operably coupled with the channel with a tilt adjustment bracket, the tilt adjustment bracket providing a plurality of detent stops such that the electronic display device can be disposed at a plurality of pre-defined tilt positions. The outer assembly may further include a vertical adjustment assembly enabling selective vertical shifting of the outer assembly relative to the scissor arms.

In further embodiments, an electronic display system includes a wall having a plurality of spaced-apart studs forming a plurality of stud spaces therebetween, and a membrane on one side of the studs, a plurality of electronic display devices, and a plurality of mounts. Each mount includes a housing having a pair of opposing side walls, a top wall, a bottom wall, and a rear wall defining an enclosure with a front opening; a pair of side flanges, each side flange presenting a front face and operably coupled to a separate one of the opposing side walls such that the side flange is selectively shiftable to alter a first distance between the front face and the rear wall of the housing; a pair of spaced-apart interface rails extending between the opposing side walls of the housing, each interface rail having a projecting lip, each the interface rail being selectively shiftable to alter a second distance between the projecting lip of the interface rail and the rear wall of the housing; and at least one display mount, each display mount removably coupled to each of the interface rails and adapted to attach to the electronic display device to couple the electronic display device to the housing. Each mount of the plurality of mounts may be arranged in a separate one of the plurality of stud spaces and through an aperture in the membrane.

In embodiments, at least one of the plurality of mounts may further include an attachment plate disposed inside the enclosure of the housing, the attachment plate adapted to receive a plurality of peripheral electronic devices selected from the group consisting of controllers, receivers, routers, and power supplies. Each mount of the plurality of mounts may be arranged immediately adjacent another one of the plurality of mounts. Each of the display mounts can include an inner assembly and an outer assembly coupled by a pair of scissor arms, the inner assembly coupled to the interface rails and the outer assembly adapted to attach to the electronic display device, the scissor arms enabling the electronic display device to be selectively shifted between a first position proximate the housing and a second position spaced-apart from the housing. The outer assembly may include a channel operably coupled to the scissor arms and a display interface adapted to attach to the electronic display device, the display interface operably coupled with the channel so as to enable the display interface to be selectively shifted relative to the channel to vertically tilt the electronic display device.

The display interface may be operably coupled with the channel with a tilt adjustment bracket, the tilt adjustment bracket providing a plurality of detent stops such that the electronic display device can be disposed at a plurality of pre-defined tilt positions, and the outer assembly may further include a vertical adjustment assembly enabling selective vertical shifting of the outer assembly relative to the scissor arms.

In an embodiment, a mount for attaching an electronic display device to a wall of a structure includes an enclosure adapted to be received in an aperture in the wall, the enclosure defining a front opening, a display mount operably coupled to the enclosure, the display mount including an inner assembly coupled to the enclosure, an outer assembly adapted to receive the electronic display device, and an extension mechanism operably coupling the inner assembly and the outer assembly. The extension mechanism enables the outer assembly to be selectively positioned in a retracted position in which the extension mechanism is received in the enclosure and the outer assembly is positioned adjacent or within the front opening of the enclosure, and an extended position in which the outer assembly is spaced apart from the front opening of the enclosure. The display mount has a latch mechanism arranged to latch the display mount in the retracted position. The latch mechanism is coupled with a release cord and has an emergency release member separate from the release cord, with the emergency release member accessible from outside the enclosure to release the latch mechanism.

According to embodiments, the extension mechanism may be a scissor arm assembly. The scissor arm assembly can include a pair of arms pivotally coupled together, and the latch mechanism can include a spring-biased latch member. The emergency release member can be an emergency release arm portion of the latch member. The outer assembly can include a track and a display interface spaced apart from the track defining a gap therebetween, with the emergency release arm portion of the latch member projecting into the gap when the display interface is in the retracted position.

In an embodiment, the outer assembly includes a track and a display interface adapted to attach to the electronic display device, the display interface operably coupled with the track so as to enable the display interface to be selectively shifted relative to the track to vertically tilt the electronic display device, the track and the display interface being spaced apart defining a gap therebetween. The latch mechanism can include a spring-biased latch member operably coupled to the extension mechanism, and the emergency release member can be an emergency release arm portion of the latch member, with the emergency release arm portion extending into the gap.

In further embodiments, the display interface is operably coupled with the track with a tilt adjustment bracket, the tilt adjustment bracket providing a plurality of detent stops such that the electronic display device can be disposed at a plurality of pre-defined tilt positions. The outer assembly can further include a vertical adjustment assembly enabling selective vertical shifting of the outer assembly relative to the extension mechanism.

In embodiments, a system for mounting an electronic display device to a wall of a structure includes a plurality of mounts, each mount including an enclosure adapted to be received in an aperture in the wall, the enclosure defining a front opening, a display mount operably coupled to the enclosure, the display mount including an inner assembly coupled to the enclosure, an outer assembly adapted to receive the electronic display device, and an extension mechanism operably coupling the inner assembly and the outer assembly, the extension mechanism enabling the outer assembly to be selectively positioned in a retracted position in which the extension mechanism is received in the enclosure and the outer assembly is positioned adjacent or within the front opening of the enclosure, and an extended position in which the outer assembly is spaced apart from the front opening of the enclosure. The display mount has a latch mechanism arranged to latch the display mount in the retracted position, the latch mechanism coupled with a release cord and having an emergency release member separate from the release cord, the emergency release member accessible from outside the enclosure to release the latch mechanism.

In embodiments, the extension mechanism can be a scissor arm assembly. The scissor arm assembly can include a pair of arms pivotally coupled together, the latch mechanism can include a spring-biased latch member, and the emergency release member can be an emergency release arm portion of the latch member. The outer assembly can include a track and a display interface spaced apart from the track defining a gap therebetween, wherein the emergency release arm portion of the latch member projects into the gap when the display interface is in the retracted position.

In further embodiments, the outer assembly includes a track and a display interface adapted to attach to the electronic display device, and the display interface is operably coupled with the track so as to enable the display interface to be selectively shifted relative to the track to vertically tilt the electronic display device, the track and the display interface being spaced apart defining a gap therebetween. The latch mechanism may include a spring-biased latch member operably coupled to the extension mechanism, and the emergency release member can be an emergency release arm portion of the latch member, the emergency release arm portion extending into the gap. The display interface may be operably coupled with the track with a tilt adjustment bracket, the tilt adjustment bracket providing a plurality of detent stops such that the electronic display device can be disposed at a plurality of pre-defined tilt positions.

In further embodiments, the outer assembly can include a vertical adjustment assembly enabling selective vertical shifting of the outer assembly relative to the scissor arms.

In embodiments, an electronic display system includes a wall having a plurality of spaced-apart studs forming a plurality of stud spaces therebetween, and a membrane on one side of the studs, a plurality of electronic display devices, and a plurality of mounts. Each mount includes an enclosure defining a front opening, a display mount operably coupled to the enclosure, the display mount including an inner assembly coupled to the enclosure, an outer assembly coupled to one of the electronic display devices, and an extension mechanism operably coupling the inner assembly and the outer assembly, the extension mechanism enabling the outer assembly to be selectively positioned in a retracted position in which the extension mechanism is received in the enclosure and the outer assembly is positioned adjacent or within the front opening of the enclosure, and an extended position in which the outer assembly is spaced apart from the front opening of the enclosure. The display mount has a latch mechanism arranged to latch the display mount in the retracted position, the latch mechanism coupled with a release cord and having an emergency release member separate from the release cord, the emergency release member accessible from outside the enclosure to release the latch mechanism. Each mount of the plurality of mounts is arranged in a separate one of the plurality of stud spaces and through an aperture in the membrane. The latch mechanism may include a spring-biased latch member, and the emergency release member can be an emergency release arm portion of the latch member. The outer assembly can be a track and a display interface spaced apart from the track defining a gap therebetween, and the emergency release arm portion of the latch member projects into the gap when the display interface is in the retracted position.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

The subject matter hereof may be more completely understood in consideration of the following detailed description of various embodiments in connection with the accompanying figures, in which:

FIG. 1 is a front isometric view of an in-wall enclosure according to embodiments of the invention;

FIG. 2 is a partially exploded view of the in-wall enclosure of FIG. 1;

FIG. 3 is a close-up view of a portion of the in-wall enclosure of FIG. 1 depicting the connection of one of the interface rails to a side flange;

FIG. 4 is a close-up view of a portion of the in-wall enclosure of FIG. 1 depicting the apertures for connection with the in-wall box to a side flange;

FIG. 5 is a rear isometric view of a portion of the in-wall enclosure of FIG. 1 depicting the side flange and attachment hardware;

FIG. 6 is another rear isometric view of a portion of the in-wall enclosure of FIG. 1 depicting the side flange and attachment hardware;

FIG. 7 is a top plan view of one of the side flanges and attachment hardware of FIGS. 5 and 6 with a wall membrane depicted in phantom;

FIG. 8 is a front isometric view of a wall and mount assembly according to an embodiment of the invention with the wall depicted in phantom;

FIG. 9 is a partial isometric view of the wall and mount assembly of FIG. 8 with the wall depicted in phantom;

FIG. 10 is a front isometric view of a wall and mount assembly according to an embodiment of the invention with mount on both sides of the wall and the wall depicted in phantom;

FIG. 11 is a front isometric view of a surface mount according to an embodiment of the invention;

FIG. 12 is a front isometric view of a display mount according to an embodiment of the invention;

FIG. 13 is a partial exploded view of the display mount of FIG. 12;

FIG. 14 is a partial exploded rear isometric view of the display mount of FIG. 12;

FIG. 15 is a rear isometric view of the display mount of FIG. 14 with portions depicted in phantom;

FIG. 16 is a cross-sectional view of the mount of FIG. 11 taken at Section 16-16 of FIG. 11;

FIG. 17 is an elevation view of the tilt adjustment bracket of the mount of FIGS. 12-15;

FIG. 18 is a front perspective view of a display mount according to FIG. 12;

FIG. 19 is a front isometric view of an in-wall television mount including an emergency release mechanism according to an embodiment of the invention;

FIG. 20 is a front isometric view of the portion of the mount of FIG. 19 denoted by Inset 20 in FIG. 19;

FIG. 21 is a partial rear isometric view of the display mount of the mount of FIG. 19;

FIG. 22 is an exploded view of the latch assembly with emergency release feature of the mount of FIG. 19;

FIG. 22A is a rear isometric view of the spring housing of the latch assembly of FIG. 22;

FIG. 23 is a top plan view of the mount of FIG. 19 with the display mount in a retracted position;

FIG. 24 is a partial top plan view of the display mount of the mount of FIG. 19 with the display mount in an extended position; and

FIG. 25 is a partial isometric view of the latch assembly of the mount of FIG. 19 with the display mount in an extended position.

While various embodiments are amenable to various modifications and alternative forms, specifics thereof have been shown by way of example in the drawings and will be described in detail. It should be understood, however, that the intention is not to limit the claimed inventions to the embodiments described. On the contrary, the invention is to cover all modifications, equivalents, and alternatives falling within the spirit and scope of the subject matter as defined by the claims.

### DETAILED DESCRIPTION OF THE DRAWINGS

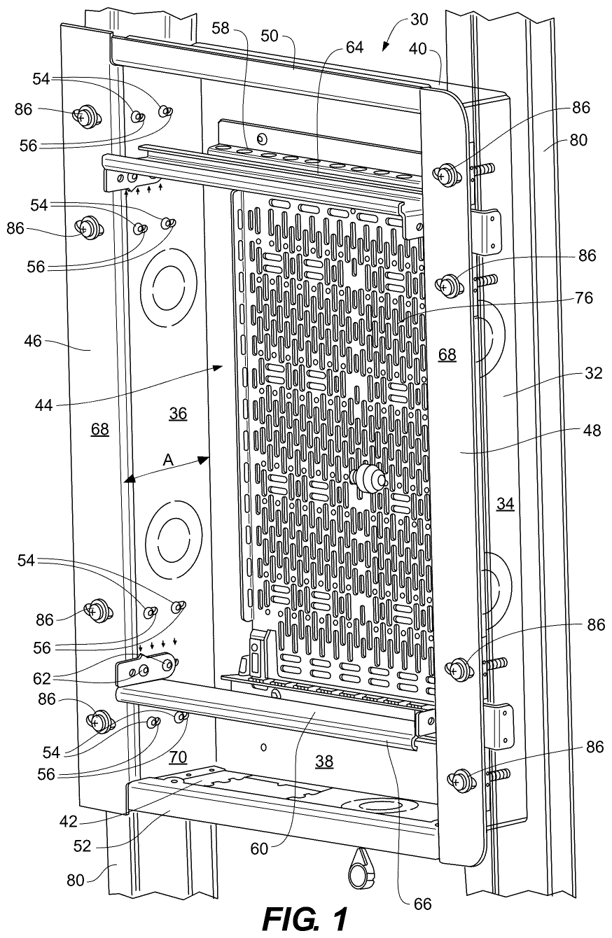

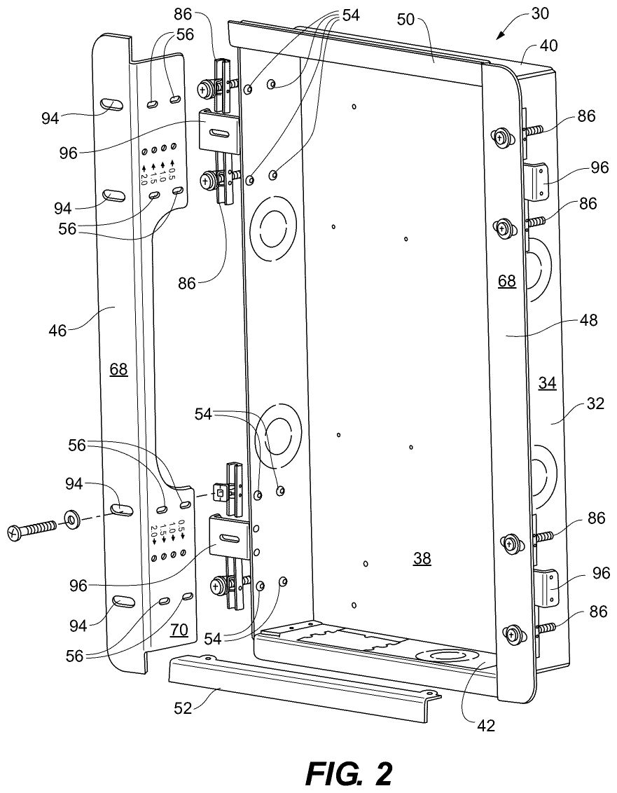

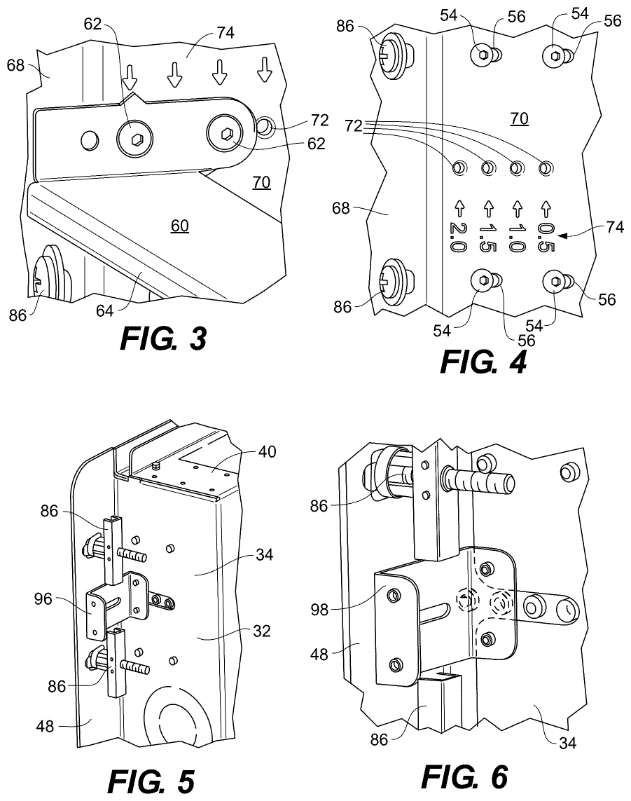

As depicted in FIG. 1, in-wall enclosure 30 generally includes housing 32, having side walls 34, 36, rear wall 38, top wall 40, bottom wall 42, and defining front opening 44. Enclosure 30 further includes side flanges 46, 48, top flange 50 and bottom connector 52. Side flanges 46, 48, are attached to housing 32 with fasteners 54 that extend through elongated slots 56 defined in side flanges 46, 48, to enable adjustment of depth dimension A and to account for varying thicknesses of sheetrock as explained in more detail below. Interface rails 58, 60 are secured to side flanges 46, 48, with fasteners 62. Interface rails 58, 60, have projecting lips 64, 66, respectively. Each of the side flanges 46,48, have front face 68 and rearwardly extending connection portion 70. Connection portion 70 can have a series of appropriately spaced apertures 72 for receiving fasteners 62 enabling projecting lips 64, 66, Of interface rails 58, 60, to be positioned at a plurality of desired positions relative to front face 68 and rear wall 38. Indicia 74 as depicted in FIGS. 3 and 4 can be provided to assist a user in positioning interface rails 58, 60. Attachment plate 76 can be affixed to rear wall 38 to enable attachment of peripherals such as controllers, receivers, routers, power supplies, and the like inside the enclosure provided by in-wall enclosure 30.

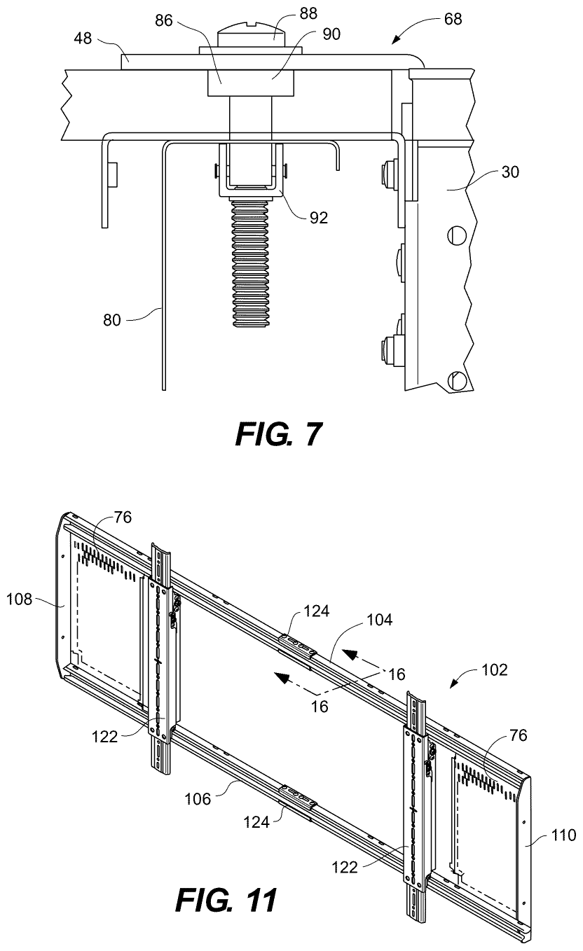

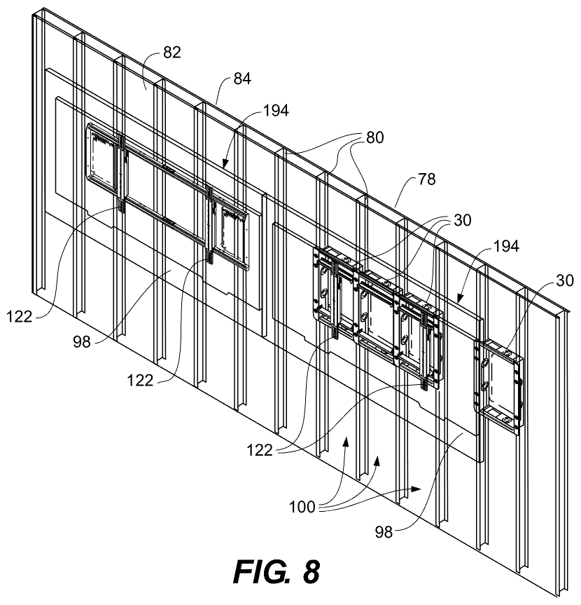

In-wall enclosure 30 can be installed in a wall structure 78. As depicted in FIGS. 8-10, wall structure 78 has vertical studs 80, which may be metal or wood, faced with membranes 82, 84, commonly made from ½ inch, ⅝ inch, or ¾ inch sheetrock. An aperture (not depicted) can be cut in membrane 82 or 84 corresponding to the dimensions of in-wall enclosure 30. In-wall enclosure 30 can be advanced into the aperture and, in the case of metal studs 80, secured in place with attachment hardware assembly 86. Each attachment hardware assembly 86 has threaded fastener 88, nut 90, and clamp 92. Nut 90 threads onto threaded fastener 88 and is pivotally coupled to clamp 92. As depicted in FIG. 7, clamp 92 can engage the rear side of membrane 82 or 84 to fasten housing 32 to wall structure 78. Threaded fasteners extend through apertures 94 in front face 68 of side flanges 46, 48. It will be appreciated that sheet metal screws (not depicted) screwed into a metal stud 80 may be substituted for attachment hardware assembly 86 in some embodiments. Alternatively, brackets 96 can be attached to the exterior surfaces of side walls 34, 36 and the in-wall box mounted prior to sheetrock installation to enable access to wiring by electricians. Each bracket 96 wraps around the front face of the stud 80, and enables the in-wall enclosures 30 to be attached to the studs 80 with screws (not depicted) through apertures 94.

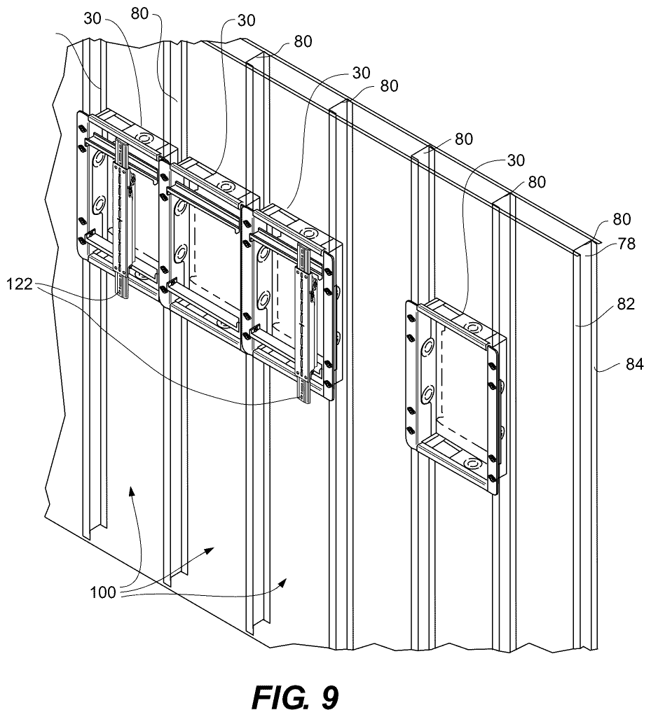

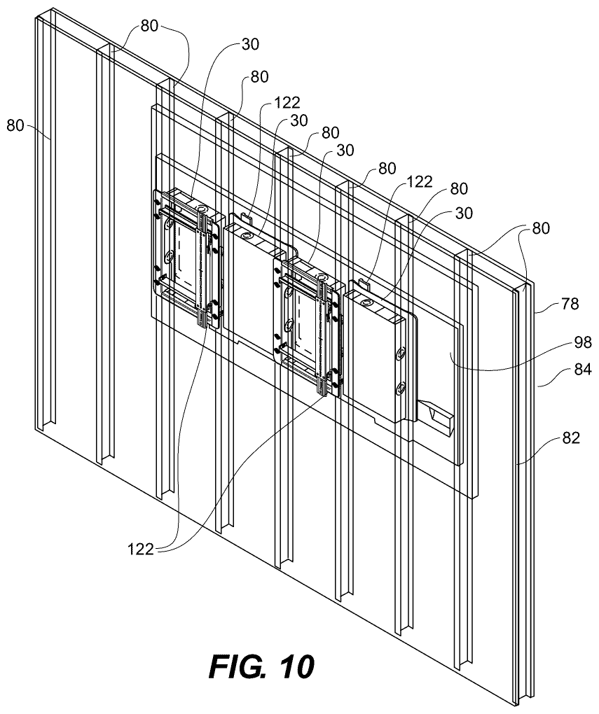

As depicted in FIGS. 8, 9, and 10, it will be appreciated that multiple in-wall enclosures 30 can be installed in wall structure 78 to provide an adaptable array of mounting points for electronic display devices, such as large televisions 98, or mounting multiple separate smaller televisions in an array. As depicted in FIGS. 8 and 9, in-wall enclosures 30 can be mounted in adjacent stud spaces 100 to provide a relatively large volume behind television 98 to conceal wiring and peripherals without the necessity of cutting any of studs 80 upon installation or install headers. Further, in-wall enclosures 30 can be installed in alternating stud spaces as depicted in FIG. 10 to provide mounts on both sides of wall structure 78, again without cutting any studs 80. It will be appreciated that television 98 can be any electronic display device such as an LCD, LED, or OLED television or monitor, or any other similar device.

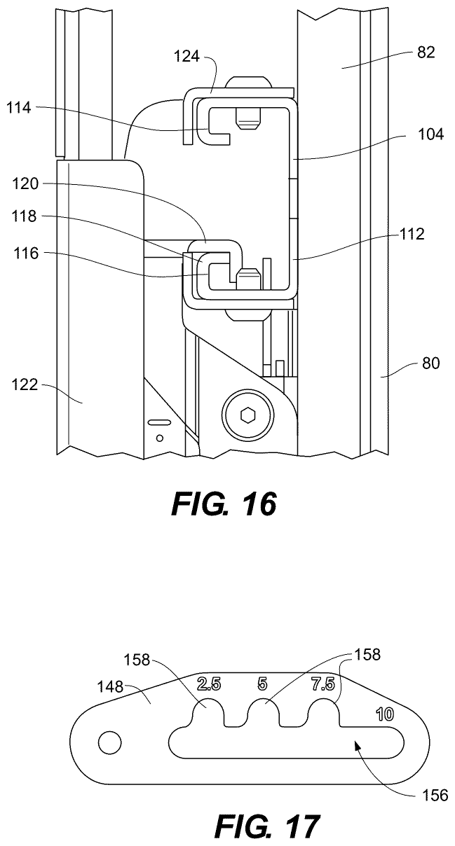

In addition, it will be appreciated that in-wall enclosures 30 can be used in conjunction with a surface mount 102 as depicted in FIGS. 8, 11, and 16. Surface mount 102 generally includes top rail 104, bottom rail 106, and end caps 108, 110. As depicted in FIG. 16, top rail 104 and bottom rail 106 can be channels with a generally c-shaped profile. Back wall 112 is mounted abutting membrane 82, and outer ends 114, 116, are turned inward to form a receiving lip 118. Hook portion 120 of display mount 122 hooks around receiving lip 118 to secure display Mount 122 to surface mount 102. Connector 124 can be used to connect longitudinally adjacent sections of channel to increase the length of top rail 104 and bottom rail 106 to thereby accommodate larger televisions. End caps 108, 110, can couple top rail 104 and bottom rail 106 to provide a more aesthetically pleasing appearance to surface mount 102. Attachment plates 76 can be added to enable mounting or peripherals such as controllers, receivers, routers, and the like behind a mounted television 98.

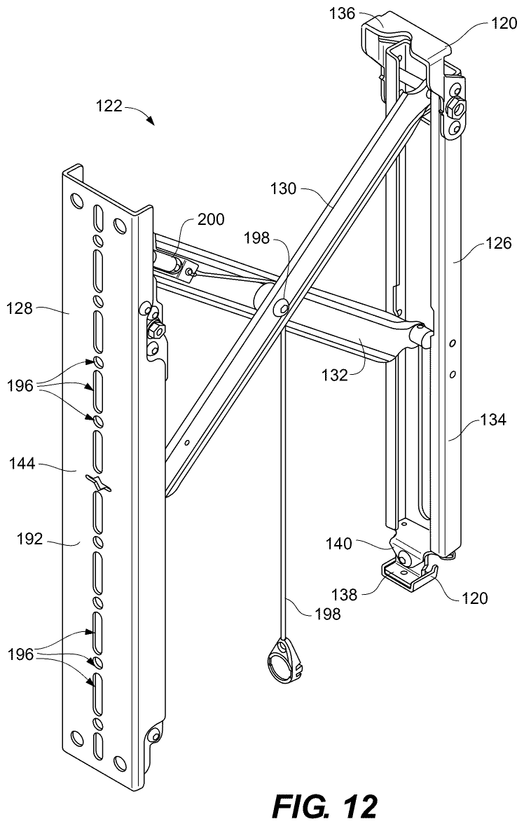

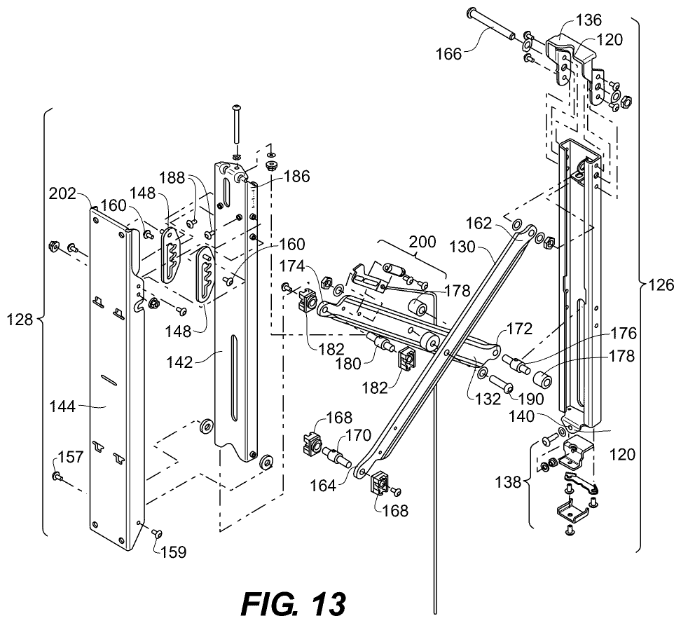

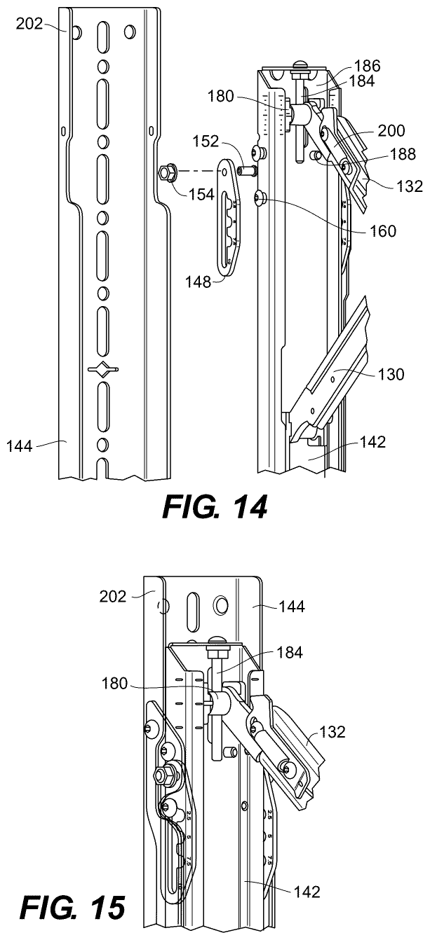

Display mount 122 is depicted in FIGS. 12-18, and generally includes inner assembly 126, outer assembly 128, and an extension mechanism 129 including scissor arms 130, 132. Inner assembly 126 generally includes track 134, top hook bracket 136 forming hook portion 120, and lower retaining assembly 138. Track 134 can be a generally c-shaped channel, and includes projecting bottom tab 140 forming hook portion 120 in conjunction with lower retaining assembly 138 at the bottom end of inner assembly 126.

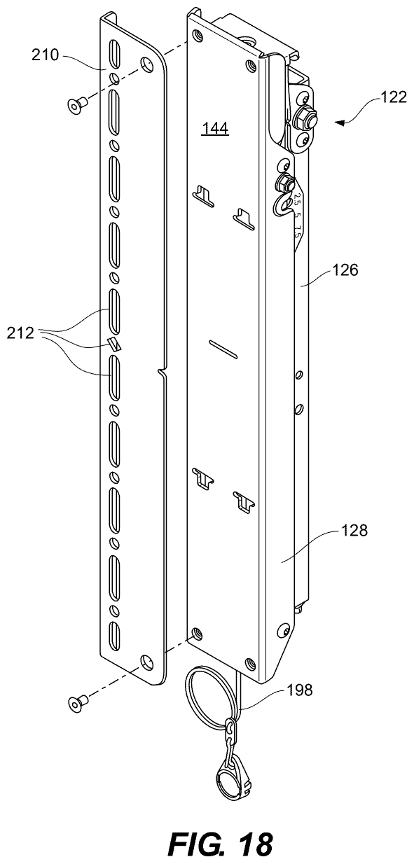

Outer assembly 128 generally includes track 142 which can be a generally c-shaped channel, display interface 144, and tilt adjustment bracket 148. Alternatively, as depicted in FIG. 18, display interface 144 can include extension 210 defining apertures 212. Tilt adjustment bracket 148 is pivotally coupled to display interface 144 with bolt 152 and nut 154 and defines slot 156 with position notches 158. Rivet 160 extends from track 142 through slot 156. Display interface 144 is pivotally coupled to track 142 at rivets 157, 159.

Scissor arm 130 presents inner end 162 and outer end 164. Inner end 162 is pivotally coupled to track 134 with bolt 166. Outer end 164 is pivotally coupled to slide blocks 168 with pin 170. Slide blocks 168 are received, and slide vertically in the channel defined by track 142. Scissor arm 132 presents inner end 172 and outer end 174. Inner end 172 carries axle 176 having rollers 178, which roll in the c-shaped channel formed by track 134. Outer end 174 carries axle 180 which is pivotally coupled with slide blocks 182. Slide blocks 182 are received, and slide vertically in the c-shaped channel defined by track 142. Axle 180 is cross drilled with an aperture (not depicted) that is threaded and receives vertical adjustment bolt 184. Slide blocks 182 are confined to sliding within the upper portion 186 of track 142 by stop screws 188. Scissor arm 130 and scissor arm 132 are pivotally coupled together with pin 190.

In use, in-wall enclosures 30 can be installed in desired positions in wall structure 78 by cutting apertures in membrane 82 between studs 80. Side flanges 46, 48, can be affixed to housing 32 with fasteners 54 to set the desired depth dimension A. Top flange 50 and bottom connector 52 can be attached to housing 32 with fasteners (not depicted). In-wall enclosures 30 can then be advanced into the apertures cut in membrane 82 or 84, and the in-wall enclosure 30 secured in place with clamp assemblies 86 in the case of steel studs or wood screws in the case of wood studs. Interface rails 58, 60, can be secured to side flanges 46, 48, with projecting lips 64, 66, in a desired position.

Display mounts 122 can then be attached to television 98 with front face 192 of display interface 144 abutting rear side 194 of television 98 using fasteners (not depicted) through aperture 196. Hook portions 120 of inner assembly 126 can be engaged with projecting lips 64, 66, to attach display mounts 122 and television 98 to in-wall enclosures 30. With television 98 attached to in-wall mounts 30, vertical adjustment bolts 184 on each display mount 122 can be rotated to adjust the relative height and skew of television 98 to confirm with the ceiling, floor, or adjacent televisions 98.

Television 98 can be tilted by pulling upper end 202 of display interface 144 to tilt outward, pivoting around rivets 157, 159. Tilt adjustment brackets 148 pivot around bolts 152, enabling slot 156 to slide around rivet 160. Notches 158 provide convenient detent stops so that upper end 202 can be disposed at pre-defined tilt positions such as 2.5, 5, 7.5, and 10 degrees relative to vertical, or can be selected to correspond to any other desired positions. Television 98 can be shifted away from the wall by pulling release cord 198 to release latch assembly 200. Television 98 can then be positioned closer to or further away from wall structure 78 via scissor arms 130, 132, and can also be pivoted to a limited degree side-to-side by differential extension of display mounts 122.

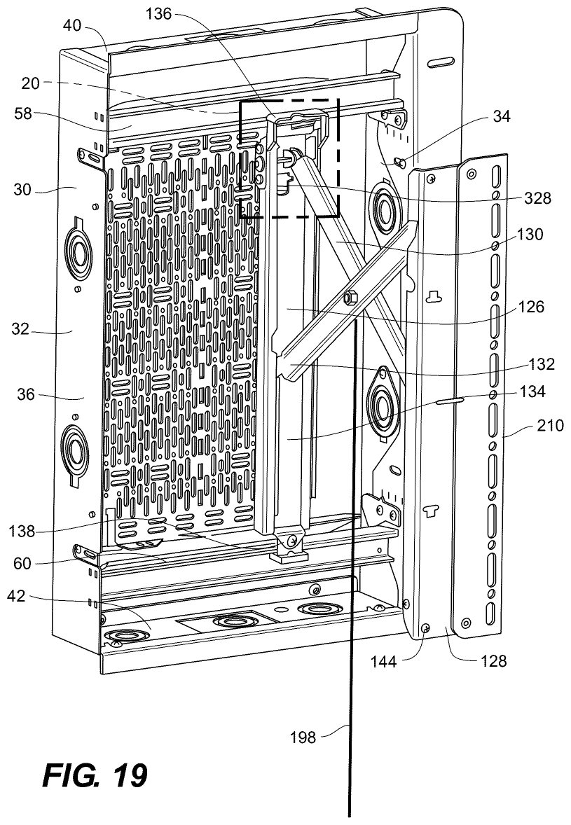

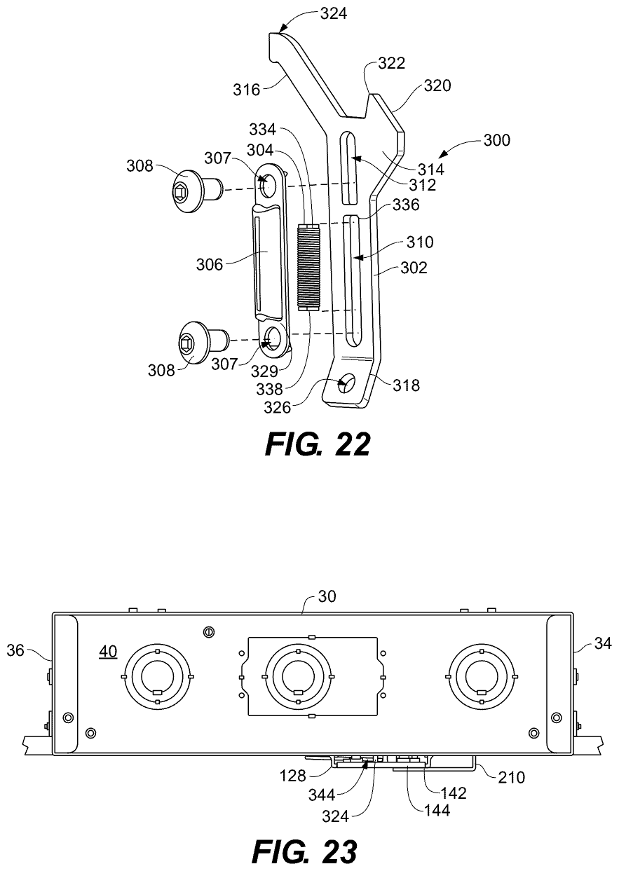

FIGS. 19-25 depict another embodiment including an emergency latch release, enabling the display mounts 122 to be released from their retracted position should release cord 198 become detached or otherwise not accessible from the front of the display. The details and operation of in-wall enclosure 30 and display mount 122 are substantially as previously described, except that latch assembly 300 is provided in place of latch assembly 200. As depicted in the exploded view of FIG. 21, latch assembly 300 generally includes latch member 302, biasing compression spring 304, spring housing 306, and fasteners 308. Latch member 302 defines elongate slots 310, 312, latch projection 314, emergency release arm 316, and release cord connection tab 318. Biasing compression spring 304 is received in elongate slot 310. Latch projection 314 presents sloped edge 320 and latch tip 322. Emergency release arm 316 presents engagement surface 324, and release cord connection tab 318 defines aperture 326. Spring housing 306 defines apertures 307. As depicted in FIG. 22A, spring housing defines semi-cylindrical recess 327 with end face 329. Projections 331 extend outwardly from inner face 333.

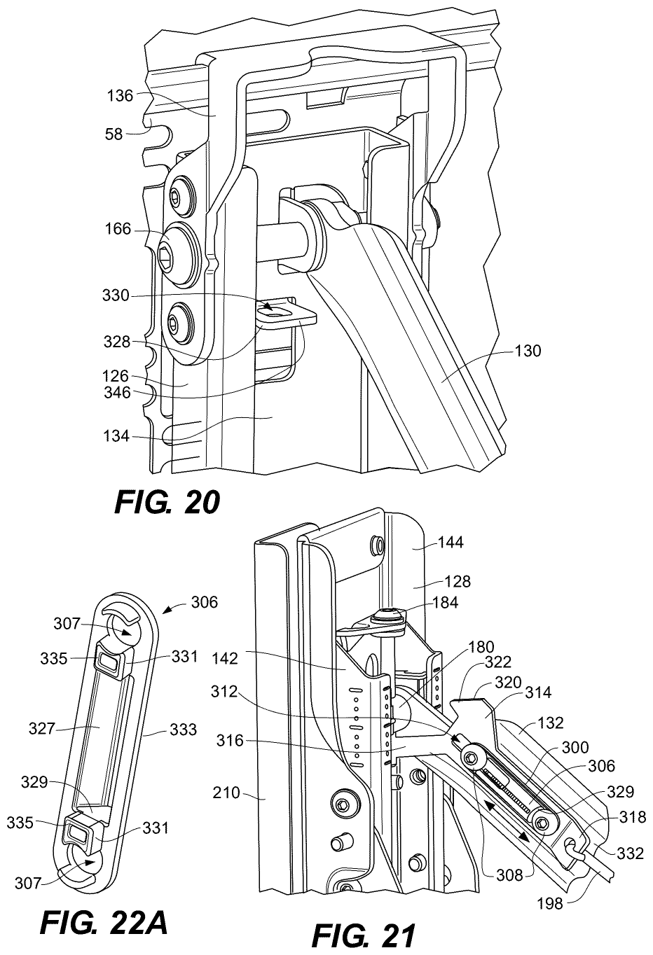

FIG. 20, which is an inset view taken from FIG. 19, depicts a portion of track 134 of inner assembly 126. Tab 328 projects outwardly from track 134 and defines aperture 330.

FIGS. 21 and 25 are isometric views of the top portion of outer assembly 128 and scissor arm 132, depicting latch assembly 300. Latch assembly 300 is mounted on side face 332 of scissor arm 132 with fasteners 308 through apertures 307 and elongate slots 310, 312, such that latch member 302 can slide on side face 332 in the directions indicated by the arrow. Projections 331 extend through elongate slots 310, 312, with ends bearing against side face 332 to enable sliding clearance between inner face 333 and side face 332 for latch member 302. End 334 of biasing compression spring 304 bears against end 336 of elongate slot 310, while end 338 of biasing compression spring 304 bears against end face 329 of spring housing 306 to bias latch member 302 relative to scissor arm 132.

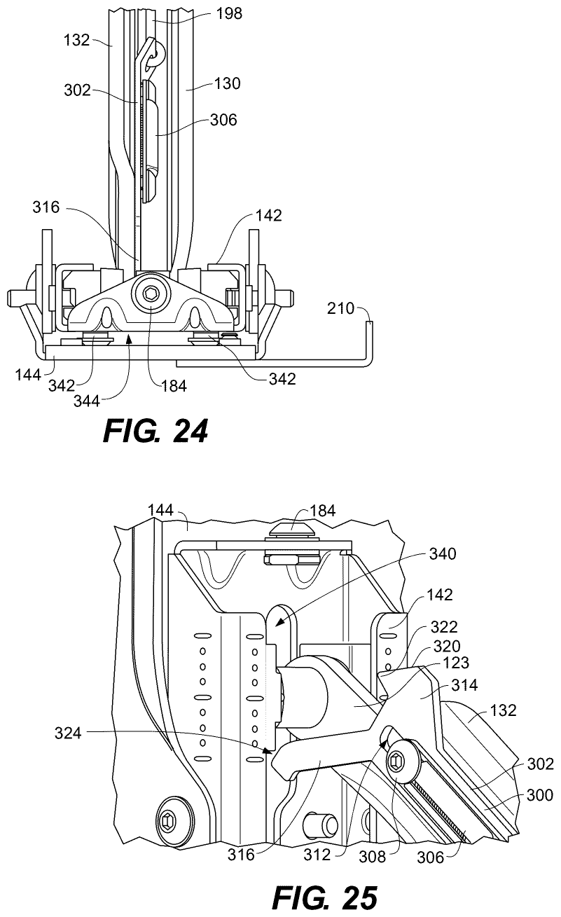

As depicted in FIG. 25, emergency release arm 316 projects forwardly into aperture 340 in track 142. FIG. 24 is a partial top plan view of the display mount 122 in an extended position. As depicted, display interface 144 is mounted to track 142 with standoffs 342, forming gap 344 between display interface 144 and track 142.

As display interface 122 is pushed toward the retracted position inside in-wall enclosure 30, sloped edge 320 of latch projection 314 engages forward edge 346 of tab 328, and latch member 302 is urged downward against the bias of biasing compression spring 304. Once latch tip 322 clears the edge of aperture 330, biasing compression spring 304 urges latch member 302 upwards, engaging latch tip 322 in aperture 330 and latching display interface 122 in the retracted position. As depicted in FIG. 23, with display interface in this position, engagement surface 324 of emergency release arm 316 projects into gap 344. From here, latch assembly 300 can be released by pulling downward on release cord 198, causing latch member 302 to move downwardly against the bias of biasing compression spring 304 until latch tip 322 clears aperture 330. Display interface 122 can be extended by pulling outwardly.

Should release cord 198 be missing, tangled, or otherwise inaccessible, latch assembly 300 can also be released by advancing a long slender object (not depicted) (e.g. a flat ruler, cardboard or wood scrap, etc.) downwardly through gap 344 to contact engagement surface 324 of emergency release arm 316. The object can then be pressed downward, thereby causing latch member 302 to move downwardly against the bias of biasing compression spring 304 until latch tip 322 clears aperture 330, releasing display mount 122 for extension.

It will be appreciated that the emergency latch release disclosed herein can be adapted to types of extension mechanism other than the scissor arms depicted herein. For instance, a single or articulating swing arm assembly could be employed to enable a display interface to be shifted closer to or away from an in-wall enclosure. In such a device, the swing arms fold into the in-wall enclosure to enable an attached display to be positioned close to the wall. The swing arms can be equipped with a latch releasable with a cord, and an emergency release accessible from outside the enclosure with a long slender object as described herein. Such arrangements are contemplated within the scope of the invention.

Hence, as set forth above, the inventions described herein can provide a flexible and modular approach to mounting larger televisions on a stud wall with an in-wall enclosure without the necessity to cut studs to install headers. Peripherals such as controllers, receivers, and routers can be installed inside the in-wall enclosure for purposes of concealment and enabling the television to be positioned closer to the wall without interference.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Suh combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A mount for attaching an electronic display device to a wall of a structure, comprising:
an enclosure adapted to be received in an aperture in the wall, the enclosure defining a front opening;
a display mount operably coupled to the enclosure, the display mount including an inner assembly coupled to the enclosure, an outer assembly adapted to receive the electronic display device, and an extension mechanism operably coupling the inner assembly and the outer assembly, the extension mechanism enabling the outer assembly to be selectively positioned in a retracted position in which the extension mechanism is received in the enclosure and the outer assembly is positioned adjacent or within the front opening of the enclosure, and an extended position in which the outer assembly is spaced apart from the front opening of the enclosure; and
wherein the display mount has a latch mechanism arranged to latch the display mount in the retracted position, the latch mechanism coupled with a release cord and having an emergency release member separate from the release cord, the emergency release member accessible from outside the enclosure to release the latch mechanism.

2. The mount of claim 1, wherein the extension mechanism comprises a scissor arm assembly.

3. The mount of claim 2, wherein the scissor arm assembly comprises a pair of arms pivotally coupled together, wherein the latch mechanism includes a spring-biased latch member, and wherein the emergency release member comprises an emergency release arm portion of the latch member.

4. The mount of claim 3, wherein the outer assembly comprises a track and a display interface spaced apart from the track defining a gap therebetween, and wherein the emergency release arm portion of the latch member projects into the gap when the display interface is in the retracted position.

5. The mount of claim 1, wherein the outer assembly comprises a track and a display interface adapted to attach to the electronic display device, the display interface operably coupled with the track so as to enable the display interface to be selectively shifted relative to the track to vertically tilt the electronic display device, the track and the display interface being spaced apart defining a gap therebetween.

6. The mount of claim 5, wherein the latch mechanism includes a spring-biased latch member operably coupled to the extension mechanism, and wherein the emergency release member comprises an emergency release arm portion of the latch member, the emergency release arm portion extending into the gap.

7. The mount of claim 6, wherein the display interface is operably coupled with the track with a tilt adjustment bracket, the tilt adjustment bracket providing a plurality of detent stops such that the electronic display device can be disposed at a plurality of pre-defined tilt positions.

8. The mount of claim 5, wherein the outer assembly further comprises a vertical adjustment assembly enabling selective vertical shifting of the outer assembly relative to the entension mechanism.

9. A system for mounting an electronic display device to a wall of a structure, the system comprising:
a plurality of mounts, each mount comprising:
an enclosure adapted to be received in an aperture in the wall, the enclosure defining a front opening;
a display mount operably coupled to the enclosure, the display mount including an inner assembly coupled to the enclosure, an outer assembly adapted to receive the electronic display device, and an extension mechanism operably coupling the inner assembly and the outer assembly, the extension mechanism enabling the outer assembly to be selectively positioned in a retracted position in which the extension mechanism is received in the enclosure and the outer assembly is positioned adjacent or within the front opening of the enclosure, and an extended position in which the outer assembly is spaced apart from the front opening of the enclosure; and
wherein the display mount has a latch mechanism arranged to latch the display mount in the retracted position, the latch mechanism coupled with a release cord and having an emergency release member separate from the release cord, the emergency release member accessible from outside the enclosure to release the latch mechanism.

10. The system of claim 9, wherein the extension mechanism comprises a scissor arm assembly.

11. The system of claim 10, wherein the scissor arm assembly comprises a pair of arms pivotally coupled together, wherein the latch mechanism includes a spring-biased latch member, and wherein the emergency release member comprises an emergency release arm portion of the latch member.

12. The system of claim 11, wherein the outer assembly comprises a track and a display interface spaced apart from the track defining a gap therebetween, and wherein the emergency release arm portion of the latch member projects into the gap when the display interface is in the retracted position.

13. The system of claim 9, wherein the outer assembly comprises a track and a display interface adapted to attach to the electronic display device, the display interface operably coupled with the track so as to enable the display interface to be selectively shifted relative to the track to vertically tilt the electronic display device, the track and the display interface being spaced apart defining a gap therebetween.

14. The system of claim 13, wherein the latch mechanism includes a spring-biased latch member operably coupled to the extension mechanism, and wherein the emergency release member comprises an emergency release arm portion of the latch member, the emergency release arm portion extending into the gap.

15. The system of claim 14, wherein the display interface is operably coupled with the track with a tilt adjustment bracket, the tilt adjustment bracket providing a plurality of detent stops such that the electronic display device can be disposed at a plurality of pre-defined tilt positions.

16. The system of claim 13, wherein the outer assembly further comprises a vertical adjustment assembly enabling selective vertical shifting of the outer assembly relative to the scissor arms.

17. An electronic display system, the system comprising:
a wall comprising a plurality of spaced-apart studs forming a plurality of stud spaces therebetween, and a membrane on one side of the studs;
a plurality of electronic display devices; and
a plurality of mounts, each mount comprising:
an enclosure defining a front opening;
a display mount operably coupled to the enclosure, the display mount including an inner assembly coupled to the enclosure, an outer assembly coupled to one of the electronic display devices, and an extension mechanism operably coupling the inner assembly and the outer assembly, the extension mechanism enabling the outer assembly to be selectively positioned in a retracted position in which the extension mechanism is received in the enclosure and the outer assembly is positioned adjacent or within the front opening of the enclosure, and an extended position in which the outer assembly is spaced apart from the front opening of the enclosure;
wherein the display mount has a latch mechanism arranged to latch the display mount in the retracted position, the latch mechanism coupled with a release cord and having an emergency release member separate from the release cord, the emergency release member accessible from outside the enclosure to release the latch mechanism; and
wherein each mount of the plurality of mounts is arranged in a separate one of the plurality of stud spaces and through an aperture in the membrane.

18. The system of claim 17, wherein the latch mechanism includes a spring-biased latch member, and wherein the emergency release member comprises an emergency release arm portion of the latch member.

19. The system of claim 18, wherein the outer assembly comprises a track and a display interface spaced apart from the track defining a gap therebetween, and wherein the emergency release arm portion of the latch member projects into the gap when the display interface is in the retracted position.
